(19) United States
(12) Patent Application Publication
(10) Pub. No.: US 2010/0179370 A1
(43) Pub. Date: Jul. 15, 2010

(54) DEVICE AND METHOD OF INERTING TOXIC MATERIALS BY PLASMA MELTING

(75) Inventors: Louis Clercq-Roques, Morcenx (FR); Franck Emmanuel Laurent Bruneau, Lapouyade (FR); Jean-Paul Robert-Arnouil, Merignac (FR)

Correspondence Address: RATNERPRESTIA, P.O. BOX 980, VALLEY FORGE, PA, 19482, US

(73) Assignee: Europlasma, Morcenx (FR)

(21) Appl. No.: 12/516,503

(22) PCT Filed: Nov. 21, 2007
(86) PCT No.: PCT/EP07/62651

§ 371 Date: Mar. 16, 2010

(30) Foreign Application Priority Data
Nov. 27, 2006 (FR) 0655127

(51) Int. Cl. A62D 3/19; B09B 3/00; C03B 5/00; C03B 5/16

(52) U.S. Cl. 588/311; 422/186; 422/119

(57) ABSTRACT

The present invention pertains to a process and an device for plasma fusion inertizing of toxic materials, consisting of a melting vessel having an internal volume defined by walls. At least one non-transferred arc plasma source intended to generate a lance of plasma is inclined toward the lower part of the melting vessel and propagated along an axis of propagation situated outside of the vertical plane containing the normal to the wall at the point of intersection of said propagation axis with said wall so as to agitate the melting bath. The melting vessel is in fluid communication with the upstream part of a refining and pouring vessel and consists of an opening to which a non-transferred arc plasma source is connected, said source being mounted so as to emit a plasma lance to strike the refining bath directly in said upstream part.

The present invention pertains to a device and a process for plasma-fusion inertization of toxic waste products, in particular wastes containing asbestos.

It is known that asbestos wastes, especially those resulting from the demolition of buildings are of a heterogeneous nature. These waste products may contain, in particular, besides mineral materials, also metallic materials, plastics or other combustible materials as well as a variable quantity of water.

Numerous attempts have been made to find a process for inertizing asbestos materials or materials containing asbestos.

Among these attempts, we may cite the stabilization before disposal by dilution of asbestos fibers and powders in a significant mass of a hydraulic binder, then drying the mass thus obtained. However, this inertization process poses the problem of long-term storage of the resulting material, this storage being of arbitrary length.

Also, processes aimed at deactivating industrial asbestos wastes by treatment at an average temperature between 500° C. and 900° C. are known patents EP 0 484 666 and EP 0 344 563. These processes do not, however, permit one to guarantee the harmlessness of the products resulting from the treatment.

In reality, only the processes of inertization by fusion, i.e., processes consisting of bringing the asbestos wastes to a high temperature, make it possible to assure the elimination of the noxious and carcinogenic character of the asbestos materials.

In reality, asbestos is essentially composed of mixed silicates of magnesium and calcium of variable composition whose melting point is higher than 1,500° C.

By bringing industrial wastes to a high temperature, typically 1,600° C., they are subject to melting, resulting in an inert product resembling glass.

The following examples describe various attempts that have most frequently been used in pilot plants but never brought to the point of industrial exploitation and are rarely used industrially because of unsatisfactory results both operationally and on the level of investment and operating costs.

It is known that asbestos can be mixed and dissolved in large quantities of glass in a flame furnace, requiring the additional use of highly effective fluxes such as borax but also very aggressive for the refractories classically used.

In addition, the flame furnaces generally entrain the unmelted asbestos fibers and powders, which necessitates their recovery by very costly processing of the fumes.

A process for induction heating consisting of placing the asbestos to be treated in a vessel already containing molten asbestos so as to form a thick film that blocks the radiation from the melt bath is also known from patent FR 2 668 726.

Under these conditions, the asbestos layer descends slowly by its own weight as the melting progresses. A generator at high frequencies between 200 and 600 kHz is used to keep the bath molten so as to supply enough energy to cause the asbestos of the upper layer to melt.

Among the drawbacks of such a procedure are the necessity of using a flux, priming of the initial melt bath by additional means and small treatment capacity, since the power is limited to less than 100 KW.

Another method, described in the patent application FR 2 853 846, consists of exposing the silicate products directly to an electromagnetic field of high frequency between 20 and 300 MHz to assure dielectric heating until reaching the melting temperature for the purpose of causing vitrification, therefore necessitating the incorporation of a flux, for example, sodium in the form of sea salt.

Another process, described in the patent application WO 9733840, combines a preheating chamber and a melting chamber for the treatment by vitrification of wastes containing asbestos. The modes of heating, by air-gas burners for preheating, by oxy-gas burners for melting as well as the range of gases treated are implemented by a very complicated and costly installation, including the method of selection of the wastes at the inlet to the preheating chamber. Finally, it cannot guarantee the absence of powder and fiber in the fumes due to the entrainment of gases in countercurrent.

There are also other methods for melting treatment, generally involving the use of oxy burners (patent JP 2001 317713 and DE 4 443 090) which offer no guarantees of the formation of an inert product and do not avoid the possibility of entrainment of the powder and fiber residues in the fumes.

Generally speaking, all installations and processes mentioned above are not in industrial use. Furthermore, their treatment capacity is also highly limited.

A thermal plasma site based on the use of non-transferred arc torches has been used to treat materials containing asbestos consisting of a melting chamber fed with bags containing the waste products introduced by gravity flow. Although the objective of inertization has been achieved in commercial exploitation, engineering and operating problems have been noted, in particular the insufficient service life of the refractories as well as the sometimes deficient implementation of the process because of fluctuations in the flow rate of the gaseous phase linked to the vaporization of organic materials upon each introduction of bags containing wastes. It has also been found that the holding time of the wastes being treated in these sites is frequently long. It may reach several hours.

The objective of the present invention is therefore to propose a device and a process for inertizing the toxic products by plasma fusion, allowing the holding time of the charge to be treated to be reduced to approximate the theoretical holding time and thereby to increase the treatment capacity of the device for a given power.

Another objective of the present invention is a process of inertization by plasma fusion permitting a reduction of the plasma generating power by the non-transferred arc plasma torches while maintaining an optimal fusion temperature for the treatment of the charge being treated.

This reduction of plasma power is advantageously obtained by injection into the fusion vessel of a fuel such as a gaseous oxidant fluid which promotes combustion of the carbonaceous material present in the charge being treated. The proportion of non-melting elements is therefore also strongly reduced.

Another purpose of the present invention is to obtain a final vitrified product displaying very few unmelted elements in order to promote its later utilization.

For this purpose, the present invention pertains to a process for plasma-fusion inertization of toxic waste products, in particular asbestos materials.

According to the present invention, this process includes the following steps:

a) a comminuted vitrifiable charge to be treated is continuously introduced into a melt bath, the comminuted charge descending by gravity into the bath, said bath being placed in a melting vessel having an internal volume defined by walls covered at least partially by refractory materials,

b) at least one plasma lance is introduced directly into the melting bath, said plasma lance being directed along an axis of propagation located outside of the vertical plane (P) containing the normal to the wall at the point of intersection of the axis of propagation with said wall so as to agitate the melting bath, each plasma lance being generated by a non-transferred arc plasma source mounted on the melting vessel,

c) at least part of the melting bath is sent to a refining bath, the refining bath being positioned in a refining and pouring vessel communicating in its upstream part with the melting vessel, the refining and pouring vessel having an internal volume defined by walls lined at least partially with refractory elements,

d) a plasma lance is sent directly into the refining bath toward the melting vessel to return any unmelted elements back to the melting bath, said plasma lance being generated by a non-transferred arc plasma source mounted in the downstream part of the refining and pouring vessel.

This continuous introduction of the comminuted charge reduces the thermal shock which adversely affects the service life of refractories. “Comminuted charge to be treated” is defined as a comminuted charge whose composition is vitrifiable. The comminuted charge has a particle size between 100 μm and 200 mm.

In different specific embodiments of this process of inertization by plasma fusion, each having its own particular advantages and capable of numerous possible technical combinations:
the plasma lance generated by each plasma source mounted on the melting vessel is oriented in the direction of the zone of the melting bath where the comminuted charges to be treated are descending,
the impact zone of each plasma lance with the melting bath is spaced away from the walls of the fusion vessel by a distance permitting avoidance of generation of hot points on said walls,
the plasma lance generated by the plasma source mounted in the downstream part of the refining and pouring vessel is sent along a central axis on the communication opening between the refining and pouring vessel and the melting vessel,
the comminuted charge to be treated is formed prior to step a) by grinding a mixture of wastes whose composition permits minimization of the melting temperature of said mixture.

It is made certain that in this charge the combustible part is finely divided and homogeneous.

One of the advantages of the device that is the subject of the present invention is the fact that the asbestos materials treated may have a variable content of asbestos, the remaining fraction being organic, preferably containing carbonaceous material. The comminuted charge to be treated may also contain inorganic and organic materials.

Finally, the fact of high temperature treatment permits the avoidance of dioxin formation, especially if asbestos materials with a high organic content are involved.
A gaseous oxidant fluid is injected tangentially to the walls of the melting vessel over at least part of its walls.

This gaseous oxidant fluid is preferably air. This gaseous oxidant fluid is preferably introduced continuously into the melting container to form a thermal protective layer protecting the refractory elements. This introduction can be done in several positions on the melting container, advantageously in a vortex.
The gaseous oxidant fluid is directed toward the part of the melting container where the comminuted charge to be treated is introduced.

This embodiment assures, besides protection of the refractory elements, an introduction of oxygen into the comminuted charge to be treated in order to promote combustion of the carbonaceous material present in said charge and thereby provide additional energy to the melting bath.
The temperature of the melting bath is measured, and the power of the plasma generated by the plasma sources mounted on the melting vessel is minimized while still maintaining a melting temperature in said bath.

The additional energy resulting from the introduction of the fuel permits the operator or operators of the device to adjust the functioning parameters of the non-transferred arc plasma torches in order to reduce or even minimize the plasma power generated by them while maintaining a temperature in the bath of the melting vessel capable of assuring the melting of the continuously introduced comminuted charge to be treated.

The process of the present invention advantageously permits the elimination of the production of dioxins and furans due to the high temperatures achieved in the melting and refining baths associated with a holding time conforming to existing laws.

This process also makes it possible to minimize the production of nitrogen oxides by continuous injection of the crushed charge leading to the production of fumes at a constant rate in combination with the injection of a gaseous oxidant fluid at ambient temperature, i.e., a cold gas that affixes the oxygen to the carbon, preferably to nitrogen.

The source or sources of the non-transferred arc plasma are arranged in the melting vessel in such a way as to deliver to the reaction zone the energy for melting and agitation of the mineral part of the comminuted charge being treated as well as the gasification energy for the organic part of said charge. This results, respectively, in a liquid bath at a high temperature and fumes also at a high temperature.

The heat transfer of the plasma energy to the incoming material is optimized, resulting, on the one hand, from the convection heat flux between the plasma flow and said material, on the other hand, by the radiant heat flux through the refractory wall at high temperature.

The plasma source or sources are equally spaced in the melting vessel, on the one hand, in such a way that the flow of the comminuted charge material, introduced advantageously by gravity, into a zone above the bath and remote from the plasma lance or lances could be mixed continuously and intimately with the melting bath without being entrained by the fumes, and on the other hand, so that the agitation of the bath resulting from mechanical effects or from the plasma lance or lances produces homogenization of said melting bath continuously fed with the incoming material of the comminuted charge being treated.

The material being treated may be at least partially solid and/or liquid and/or gaseous.

The present invention also pertains to a device for implementing the process of plasma fusion inertization described above. This device consists of a melting vessel or container having an internal volume defined by walls that are at least partially lined with refractory elements. The melting vessel also consists of a port for introduction of a comminuted vitrifiable charge that is to be treated.

According to the present invention, the device consists of:
at least one non-transferred arc plasma source intended to generate a plasma lance, said plasma source being connected to a side opening of the melting container,
said plasma source being installed on the melting container in such a way that the plasma lance emitted by the source is inclined toward the lower part of the container intended to receive a melting bath and is propagated along an axis of propagation situated outside of the vertical plane (P) containing the normal to the wall at the point of intersection of said axis of propagation with said wall so as to agitate the melting bath,
the melting container is in liquid communication with the upstream part of a refining and pouring vessel, said refining and pouring vessel having an internal volume defined by walls lined at least partially with refractory elements, the refining and pouring vessel being intended to receive a refining bath,
the refining and pouring vessel contains in its downstream part an opening to which a non-transferred arc plasma source is connected, said source being installed so as to emit an inclined plasma lance toward the lower part of the refining and pouring vessel in order to hit the refining bath directly in the part upstream from the refining and pouring vessel so as to push any unmelted elements back to the melting bath.

This last plasma lance also assures that the melting temperature of the refining bath is maintained in the melting and pouring vessel.

In different specific embodiments of this device, each having its own particular advantages and capable of numerous possible technical combinations:
the device consists of two non-transferred arc plasma sources, each on a side opening of the melting vessel, said sources being intended to emit plasma lances striking the melting bath asymmetrically to agitate the melting bath,

This agitation of the bath by rotation of the melting bath in the zones of impact of the plasma lances assures homogenization of the bath as well as elimination of possible unmelted residues.
the device includes measuring devices for monitoring said melting bath to permit at least one operator to control the plasma power generated by said plasma sources in real time,

In addition, the device may display means for measuring the temperature in the refining bath as well as the height of said bath in order to program the cycle of pouring of the molten products.
the vessel displays openings for the injection of a gaseous oxidant fluid, said openings being connected to a gaseous oxidant fluid injection circuit,
these openings are divided in a regular or irregular manner along a vertical axis, said vertical axis being positioned between the or one of the plasma sources of the melting vessel and the port of introduction of the comminuted charge to be treated,
the device contains means for continuous introduction of said comminuted charge to be treated connected to said introduction port,

These means of continuous introduction of the comminuted charge to be treated are advantageously chosen from the group consisting of a furnace charging screw conveyer and a pusher.
the plasma sources are mounted on the openings in such a way that the plasma lance emitted by each of these sources is inclined at an angle between 15° and 30° relative to a horizontal plane.

The present invention also pertains to a vitrified material obtained by the inertization process by plasma fusion of toxic products as described above.

According to the present invention, this material consists of a proportion of unmelted elements less than or equal to 0.1 percent by weight.

Finally, the present invention pertains to the use of the device described above for the treatment of wastes containing asbestos.

The present invention will be described in more detail with reference to the attached drawings, in which:

FIG. 1 shows a partial cutaway view of the device for plasma fusion inertization of toxic products according to one particular embodiment of the present invention;

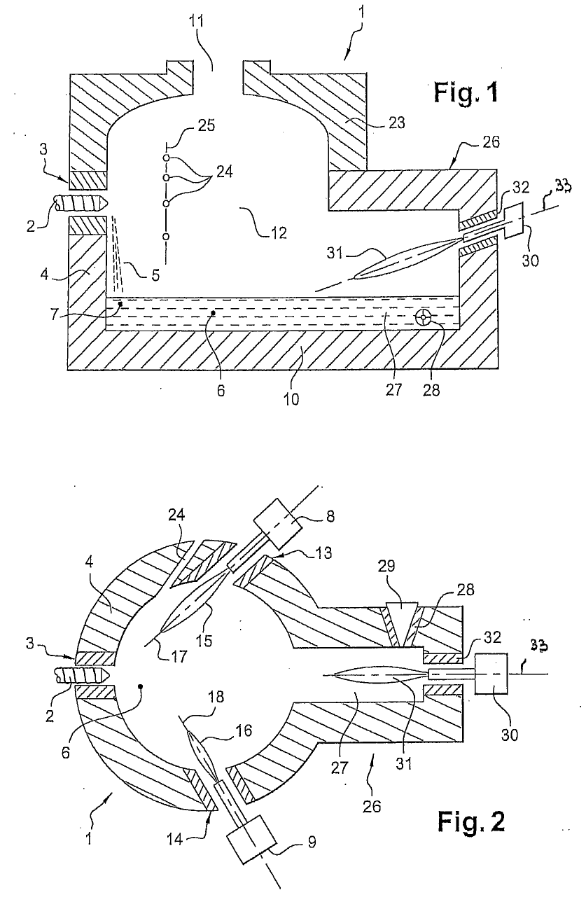

FIG. 2 is a schematic representation of the inertization device in FIG. 1 in a cutaway view from the top;

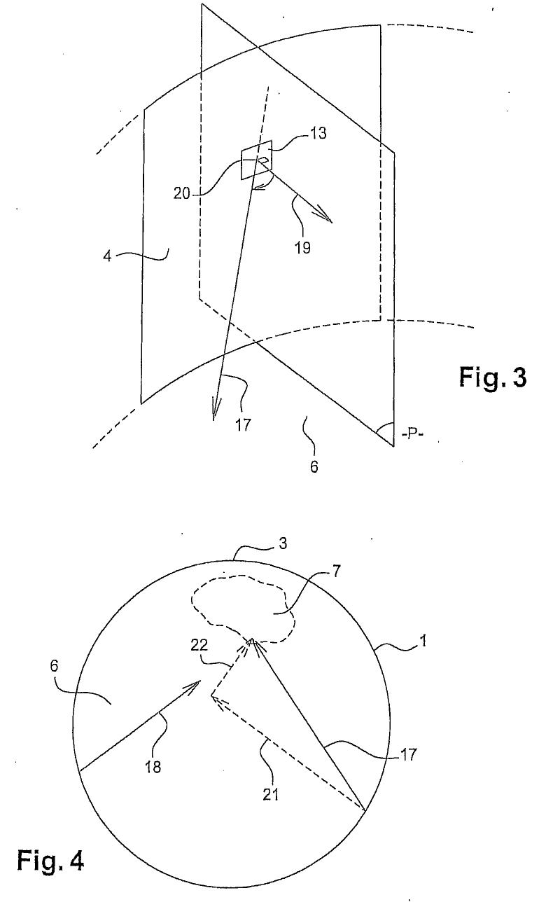

FIG. 3 represents schematically a partial view of the melting vessel of the device shown in FIG. 1, showing the axis of propagation of the plasma lance slanted toward the melting bath and with a skewed orientation;

FIG. 4 shows a cutaway top view of a melting vessel according to another embodiment of the present invention;

FIG. 1 shows a partial cutaway view of the device for plasma fusion inertization of toxic products according to one particular embodiment of the present invention. This device has a melting vessel or furnace 1 of cylindrical shape. However, this vessel may also have any other shape, such as ovoid.

The melting vessel 1 is fed continuously upstream by a flow of comminuted solid asbestos-containing material by an injection element 2. An introduction port 3 through an opening of circular section formed in a tap hole positioned in the side wall 4 of the melting vessel 1 permits the injection of the comminuted charge 5 to be treated in the melting vessel 1.

This injection element 2 is chosen because of its ability to deliver a controlled flow at a pressure and a temperature imposed by the temperature and pressure conditions prevailing in the melting vessel 1. As an example, a cooled screw 2 could be employed; it is also possible to select injection means using a plunger or compressed air transportation.

The comminuted charge 5 injected into the melting vessel 1 moves down by gravity to a melting bath 6. The impact zone of this comminuted charge 5 with the melting bath 6 constitutes a mixing zone 7. The latter is a zone where the comminuted charge 5 to be treated is mixed with that which was already brought to high temperature in the liquid state by the supply of energy of the non-transferred arc plasma torches 8, 9 (FIG. 2) in the liquid melting bath 6 contained in a crucible 10.

The melting vessel 1 has an exit port 11 positioned in the upper part of the melting vessel 1 which receives the vaporized fraction of the comminuted charge which results from thermochemical reactions in zones 7, 6 and 12 at high temperature, typically between 1,400° C. and 1,600° C. of the melting vessel 1. This exit port 11 is connected to a circuit for removal and treatment of the fumes.

The non-transferred arc plasma torches 8, 9 are mounted on the openings of circular and/or ovoid section provided in the tap holes 13, 14 in the side wall 4 of the melting vessel 1.

The non-transferred arc plasma torches 8, 9 are mounted on the melting vessel 1 in such a way that the plasma lances 15, 16, which are essentially cylindrical, emitted by each source are sent directly into the melting bath 6 and propagated along an axis of propagation 17, 18.

This axis of propagation is located outside of the vertical plane P containing the normal 19 to the wall 4 at the point 20 of intersection of this axis 17, 18 with said wall 4 of the melting vessel 1 (FIG. 3). Therefore, each plasma lance 15, 16 is sent on a sloping path toward the melting bath 6 and skewed in order to agitate it.

More precisely, the plasma lances 15, 16 are oriented toward the melting bath 6, e.g., with an angle on the order of 20° relative to the horizontal in order to benefit from the high heat transfer between the plasma and the material (that to be melted and that already melted) by a mechanical impact directly between the plasma lance and the material, which results from the high speed of the plasma on the order of, e.g., 400 m/sec.

Moreover, each axis of propagation 17, 18 of the plasma lances 15, 16, when it is projected on a horizontal plane combines a radial component 21 and a tangential component 22 with respect to the wall 4 of the vessel 1 to induce agitation in the center of the bath. This agitation may be optimized, on the one hand, by mechanical means for regulating the axial position of each non-transferred arc plasma torch, and on the other hand, by a dissymmetry of impact of the melting bath 6 by the two plasma lances 15, 16. Each of them therefore has its own radial component 21 and its own tangential component 22 so as to induce agitation of the bath by rotation of the liquid phase.

Advantageously, these torches 8, 9 are mounted on the melting vessel 1 in such a way that the plasma lances 15, 16 are sent in the direction of zone 7 of the melting bath 1 where the comminuted charges 5 to be treated are dropping (FIG. 4).

This configuration and the operating mode that results advantageously accelerate the mixing of the flow of injected material by gravity in the mixing zone 7 of the melting bath 6. The result is a more temperature-homogeneous treatment—up to 1,600° C. —a reduction of the melting time and a minimization of the proportion of unmelted material in the melting bath 6.

In addition, the values of the radial components 21 and tangential components 22 are chosen such that the impact zones of the plasma lances at the bath level are far enough away from the walls 4 of the vessel 1 not to create hot points that could be harmful for the condition of the refractory elements lining the walls.

The side wall 4, crucible 10, and crown 23 of the melting vessel 1 are all lined on the inside with refractory material with high temperature stability, e.g., based on chrome/corundum.

The torches 8, 9 preferably operate with compressed air treated as plasmagenic gas, utilizing the means of compression and treating from the atmospheric air. It is also possible to use another plasmagenic gas, e.g., by modifying the proportions of oxygen and nitrogen relative to atmospheric air.

The melting vessel 1 displays openings 24 for the injection of a gaseous oxidant fluid, said openings 24 being connected to a gaseous oxidant fluid injection circuit (not shown). The latter may consist of a compressor for injecting said fluid in pressurized form. The openings 24 are so oriented that the gaseous oxidant fluid is injected tangentially to the side wall 4 of the melting vessel 1 in the direction of the part of the melting vessel containing the port 3 for introducing a comminuted charge to be treated. These openings 24 are divided in a regular or irregular manner along a vertical axis 25, said vertical axis 25 being positioned between the plasma source 8 of the melting vessel 1 and the port 3 for introduction of the comminuted charge 5 to be treated (FIG. 2).

This flow of gas at ambient temperature, preferably air, forms a film of air serving as heat insulation covering the inner wall of the melting vessel 1.

Means for measuring and control permit the detection of the pressure and temperature in the melting vessel 1 by the pressure and temperature probes, the temperature of the bath by an optic pyrometer, the monitoring of the melting of the comminuted charge 5 by an endoscope (not shown). The measurements are employed, for example, under the control of a processing unit, for example, a microprocessor programmed for this purpose, in order to determine the electric power of the torches 8, 9 and/or the rate of introduction into the melting bath 6 of the comminuted charge to be treated for the purpose of monitoring and optimizing the melting process and, in particular, the plasma electric power necessary and sufficient to melt the comminuted charge.

The melting vessel 1 is in fluid communication with the upstream part of a refining and pouring vessel 26. The refining and pouring vessel 26 has an essentially rectangular shape but may have any other shape chosen from the group consisting of parallelepiped, tapered, cylindrical and ovoid. The refining and pouring vessel 26 is preferably placed opposite the introduction port 3 of said comminuted charge 5 to be treated.

This refining and pouring vessel 26 holds a refining bath 27 and displays a pouring opening 28 positioned preferably at the side of said vessel. The pouring opening 28 has a preferably tapered cross section and is blocked by a stopper 29, preferably of conical shape, and cooled.

The refining and pouring vessel 26 contains in its downstream part an opening to which a non-transferred arc plasma source 30 is connected. This plasma source 30 is installed in such a way as to emit a plasma lance 31 slanted toward the lower part of the refining and pouring vessel 26 to heat the refining bath 27 directly in the part upstream from the refining and pouring vessel 26. This lance thus permits imparting a quantity of movement to any unmelted elements in order to push them toward the melting bath 6. It also permits the maintaining of a melting temperature in the refining bath 27. The plasma lance 31 is propagated along a primary axis 33 forming an angle typically between 15° and 30° relative to the horizontal.

The refining bath 27 is thus fed directly and continuously by the melting bath 6 to produce a liquid bath of preferentially rectangular cross section. The latter is maintained at temperature by the supply of thermal energy produced by the plasma torch 30 installed in a tap hole 32 of circular cross section.

When the blocker 29 is in place, the supply of energy by the plasma torch 30 leads to the elimination of any unmelted residue, thereby optimizing the melting process for total elimination in the case of asbestos wastes, of asbestos in the state of powder or fibers.

When the blocker 29 is withdrawn, preferentially by hydraulic means, the liquid bath 27 flows out continuously to the atmosphere through the flow opening 28. The supply of energy by the torch 30 permits this continuous flow without risk of freezing, which could result from contact between the molten material and the ambient air at lower temperature. The material is then cooled further in air, converting it into a nontoxic vitrified material.

The refining and pouring vessel 26 is lined on its internal hot face with refractory elements with high thermal stability, e.g., based on chrome/corundum. The refractory elements of this vessel being under less stress than those equipping the melting vessel 1 due to the lower aerothermodynamic pressures, it is not necessary to install additional means to increase the service life of these refractory elements.

Means for measuring and control permit the detection of the pressure and temperature in the refining and pouring vessel 26, and the level of the bath by thickness measurement. These measurements are used to determine the start and duration of the pouring phase.

In a particular embodiment and for purely illustrative purposes, a plant for treating approximately 40 tons per day displays the following primary dimensional characteristics.
the melting vessel 1 has an inner diameter on the order of 3 m for a height between 2 and 3 m,
the refining chamber of parallelepiped shape has a width on the order of 1.5 m for a height between 1.5 and 2 m,
the overall length in a horizontal plane of the vessel/refining chamber assembly, and on the order of 4 to 5 m [sic],
the height of the bath is between 200 and 300 mm.

The conducting of the process that results from the measurement and control means described above facilitated by continuous injection of crushed material promoting the discharge of fumes may be further improved, e.g., by selecting batches of wastes containing an essentially constant vaporizable mass fraction and of the same chemical nature.

Moreover, it is clear that the use of high temperature plasma (enthalpy on the order of 6 to 7 MJ/kg) leads to minimization of the total output of fumes through a limited contribution by the plasma to said total output. All of these factors contribute to optimizing the treatment of the fumes extracted from the melting vessel 1 through the exit port 11.

This plant for treating 40 tons per day of crushed asbestos wastes requires a total electric power of the plasma on the order of 1.5 MW, split up into two times 500 kW for two non-transferred arc plasma torches 8, 9 mounted on the melting vessel 1 and 500 kW for the non-transferred arc plasma torch 30 installed downstream from the refining and pouring vessel 26.

The oxidant gas flow rate at ambient temperature when injected into the melting vessel 1 is in the range of 800 to 1,200 Nm³/hr.

For standard asbestos wastes, e.g., a mixture of approximately 50% powdered wastes and 50% fiber wastes, the vaporizable fraction of the wastes represents a flow rate of about 900 to 1,000 Nm³/hr.

For a plasma electric power on the order of 1.5 MW, the flow rate of the plasmagenic gas is on the order of 450 to 500 Nm³/hr, which corresponds to an enthalpy of the plasma on the order of 6 to 7 MJ/kg.

Total output of fumes is in the range of 2,500 to 3,000 Nm³/hr. Under these operating conditions, the rate of emission of nitrogen oxides into the atmosphere is lower than the required threshold of 400 mg/Nm³.

It should be noted that the energy balance is still about 1 kWh/kg. Since the plasma torches have an efficiency of about 80% to 85% (ratio between thermal energy delivered and electrical energy consumed), with consideration of the energy balance, it can be concluded that the plasma fusion inertization process has very high energy efficiency.

The vitrified product resulting from the fusion, e.g., 20 to 25 tons per day for a treatment capacity of 40 tons/day is totally inert, and in addition not a single trace of asbestos in the fibrous or powdered state can be detected. It is therefore a reusable product, e.g., because of its mechanical properties, as underbedding for roads.

1. Process for plasma fusion inertizing of toxic products, comprising:
a) continuously introducing a comminuted vitrifiable charge to be treated into a melt bath, said comminuted charge descending by gravity into said bath, said bath being placed in a melting vessel having an internal volume defined by walls covered at least partially by refractory materials,
b) introducing at least one plasma lance directly into the melting bath, said plasma lance being directed along an axis of propagation located outside of the vertical plane containing the normal to the wall at the point of intersection of said axis of propagation with said wall so as to agitate the melting bath, each plasma lance being generated by a non-transferred arc plasma source mounted on the melting vessel,
c) sending at least a part of the melting bath to a refining bath, said refining bath being positioned in a refining and pouring vessel in communication in its upstream part with said melting vessel, said refining and pouring vessel having an internal volume defined by walls lined at least partially with refractory elements,
d) sending a plasma lance directly into the refining bath toward the upstream part of said refining and pouring vessel in communication with said melting vessel to push toward the melting bath any unmelted elements, said plasma lance being generated by a non-transferred arc plasma source mounted in the downstream part of said refining and pouring vessel.

2. Process in accordance with claim 1, wherein the plasma lance generated by each of said plasma sources mounted on said melting vessel is oriented in the direction of the zone of said melting bath where said comminuted charges to be treated fall.

3. Process in accordance with claim 1 wherein the impact zone of each plasma lance with said melting bath is separated from the walls of said melting vessel by a distance permitting the avoidance of the generation of hot points on said walls.

4. Process in accordance with claim 1 wherein said comminuted charge to be treated is formed prior to step a) by comminution of a mixture of wastes whose composition permits the minimization of the melting temperatures of the mixture.

5. Process in accordance with claim 1 wherein the plasma lance generated by said plasma source mounted in the downstream part of said refining and pouring vessel is sent along a central axis on the communication opening between said refining and pouring vessel and said melting vessel.

6. Process in accordance with claim 1 wherein a gaseous oxidant fluid is injected at ambient temperature tangentially to the walls of the melting vessel over at least a part of said walls.

7. Process in accordance with claim 6, wherein the gaseous oxidant fluid is directed toward the part of the melting container where the comminuted charge to be treated is introduced.

8. Process in accordance with claim 6 wherein a temperature of the melting bath is measured, and a power of the plasma generated by the plasma sources mounted on the melting vessel is minimized while still maintaining a melting temperature in said bath.

9. Device for implementation of the plasma fusion inertization process for toxic products comprising
a melting vessel having an internal volume defined by walls, said walls being at least partially lined with refractory elements, said vessel having an introduction port for a vitrifiable comminuted charge to be treated, wherein the melting vessel includes:
at least one non-transferred arc plasma source intended to generate a plasma lance, said plasma source being connected to a side opening of said melting vessel,
said plasma source being mounted on said melting vessel in such a way that the plasma lance emitted by said sources is inclined toward the lower part of said vessel intended to receive a melting bath and is propagated along an axis of propagation situated outside of the vertical plane (P) containing the normal to the wall at the point of intersection of said axis of propagation with said wall so as to agitate said melting bath,
said melting vessel is in liquid communication with the upstream part of a refining and pouring vessel, said refining and pouring vessel having an internal volume defined by walls lined at least partially with refractory elements, said refining and pouring vessel being intended to receive a refining bath,
said refining and pouring vessel contains in its downstream part an opening to which a non-transferred arc plasma source is connected, said source being installed so as to emit a plasma lance inclined toward the lower part of said refining and pouring vessel in order to hit the refining bath directly in the part upstream from the refining and pouring vessel so as to push any unmelted elements back to the melting bath.

10. Device in accordance with claim 9, further comprising of two non-transferred arc plasma sources each mounted on a side opening of said melting vessel, said sources being intended to emit plasma lances striking the melting bath asymmetrically to agitate the melting bath.

11. Device in accordance with claim 9 wherein said melting vessel further includes injection openings for a gaseous oxidant fluid, said openings being connected to an injection circuit of said gaseous oxidant fluid.

12. Device in accordance with claim 11, wherein said openings are so oriented that the gaseous oxidant fluid is injected tangentially to the side wall of said vessel in the direction of the part of the melting container containing the introduction port for the comminuted charge to be treated.

13. Device in accordance with claim 11, wherein said openings are divided in a regular or irregular manner along a vertical axis, said vertical axis being positioned between one of said plasma sources of the melting vessel and said introduction port for the comminuted charge to be treated.

14. Device in accordance with claim 9 wherein said non-transferred arc plasma sources are mounted on the melting vessel in such a way that said plasma lances emitted by said sources are sent in the direction of the zone of said melting bath where said comminuted charges to be treated drop down.

15. Device in accordance with claim 9 further including measuring devices for monitoring said melting bath to permit at least one operator to control the plasma power generated by said plasma sources in real time.

16. Device in accordance with claim 9 wherein the refining and pouring vessel is positioned opposite the introduction port for said comminuted charge to be treated.

17. Device in accordance with claim 9 further including means for continuous introduction of said comminuted charge to be treated that are connected to said introduction port.

18. Device in accordance with claim 9 wherein said plasma sources are mounted on said openings in such a way that said plasma lance emitted by each of said sources is inclined at an angle between 15° and 30° relative to a horizontal plane.

19. Device in accordance with claim 9 wherein the refining and pouring vessel displays a pouring opening blocked by a blocking device.

20. Use of the device in accordance with claim 9 for treating wastes containing asbestos.

21. Vitrified material obtained by the process of inertization by plasma fusion of toxic products in accordance with claim 1 wherein said material consists of a proportion of unmelted elements less than or equal to 0.1 percent by weight.
